(19) United States
(12) Patent Application Publication
(10) Pub. No.: US 2013/0100461 A1
(43) Pub. Date: Apr. 25, 2013

(54) METHODS AND APPARATUSES FOR POSITION AND FORCE DETECTION

(71) Applicants: Reinold Wischnewski, Utting (DE); Hendrik Herrmann, Bernried (DE)

(72) Inventors: Reinold Wischnewski, Utting (DE); Hendrik Herrmann, Bernried (DE)

(73) Assignee: CARL ZEISS MICROSCOPY GMBH, Jena (DE)

(21) Appl. No.: 13/640,756

(22) PCT Filed: Mar. 23, 2011
(86) PCT No.: PCT/EP2011/054428

§ 371 Date: Dec. 21, 2012

(30) Foreign Application Priority Data
Apr. 14, 2010 (DE) 10 2010 027 720.7

(51) Int. Cl. G01B 11/14

(52) U.S. Cl. CPC G01B 11/14
USPC 356/614

(57) ABSTRACT

Methods and apparatuses for detection of a force acting on an object trapped in optical tweezers and/or for detection of a position change of an object illuminated by a light beam are described. In this respect, light scattered from the object is guided via a telescope arrangement to a detector such that a diverging beam falls onto the detector.

### FIELD OF THE INVENTION

The present invention relates to methods and apparatuses for detecting positions of objects irradiated with a light beam, for example a laser beam, wherein in particular a position relative to the laser beam may be determined. The present invention additionally relates to methods and apparatuses for detecting or measuring a force which acts on an object trapped by optical tweezers or for detecting or measuring of forces which act on a plurality of objects trapped in a plurality of optical tweezers.

### BACKGROUND

Optical tweezers, also referred to as optical traps, an object the dimensions of which typically are in the micrometer or nanometer range is kept at or nearby a focus of a strongly focussed laser beam. By strongly focussing the laser beam an electric field with a large gradient is generated. A dipole induced by the electromagnetic field of the laser beam allows for a manipulation of the object and causes for example a force along a gradient of the electric field in the direction of the location of maximum light intensity, i.e. towards the focus of the laser beam.

Forces acting on a thus trapped object may be detected by evaluating light scattered by the object in the backward or forward direction. Corresponding apparatuses and methods are for example known from WO 2008/145110 A1 or WO 2009/065519 A1. In a corresponding manner a position displacement of an object in a laser beam, i.e. an object irradiated by this laser beam, may be detected.

In conventional methods for force detection a detector is usually placed in a back focal plane. The force detection then takes place via an intensity displacement of the reflection falling on the detector.

In backward detection this has the disadvantage that the manner and behaviour of the intensity displacement depends on the size of the trapped object;

with some object sizes this principle may only be applied under difficulties or not at all.

It is therefore an object of the present invention to provide apparatuses and methods in which a detecting of a force acting on an object being in optical tweezers is simplified and is provided in particular more independently of an object size. In some embodiments, it would be desirable to extend this on objects moved by a movement of the laser beam and/or to a plurality of objects trapped by a plurality of optical tweezers.

### SUMMARY

According to an embodiment a method for detecting a force acting on an object being in an optical trap or for determining a position of an object being in a light beam is provided, comprising:

guiding of light scattered from the object to a telescope arrangement,

detecting a light beam emitted by the telescope arrangement,

wherein the telescope arrangement is configured such that the light beam emitted by the telescope arrangement diverges.

By using a telescope arrangement which generates a diverging light beam it is possible to detect a displacement of the light beam emitted by the telescope arrangement on a detector when a force acts or a position change occurs. Therefore the detection of the force is simplified.

The detector may be positioned relative to the telescope arrangement such that the light beam emitted by the telescope arrangement irradiates less than 100%, for example between 50 and 90%, of an area of the detector.

Such a method may be applied both in a forward scattering geometry and in a backscattering geometry. In a backscattering geometry the method may comprise the coupling of light backscattered from the object out of a light path of a light beam falling on the object, for example a laser beam, wherein the light coupled out is guided to the telescope arrangement.

A light beam, in particular a laser beam, for generating the optical tweezers may be configured to be movable such that the object may be moved by moving, for example displacing, the light beam. In this case the telescope arrangement may comprise at least one movable optical element to let the scattered light fall at least approximately on a same spot of the detector, for example a zero spot, as long as no force acts on the objects, independently from the movement of the light beam. By this independently from a moving of the light beam a constant detection behaviour of the detector is made possible.

In an embodiment two laser beams for providing two optical tweezers may be provided, wherein the laser beams may for example differ in their polarization or their wavelengths. In this case the telescope arrangement may comprises elements which are associated with both light beams and additional elements which are each associated only with one of the light beams. A separation of scattered light of a first one of the light beams from scattered light of a second one of the light beams may then take place within the telescope arrangement. By this a compact assembly is made possible.

### BRIEF DESCRIPTION OF THE DRAWINGS

In the following the invention will be explained with reference to the attached drawings in more detail, wherein:

FIG. 1 is a schematic diagram of an optical apparatus according to an embodiment;

FIG. 2 is a schematic diagram of an optical apparatus according to a further embodiment;

FIG. 3 is a schematic diagram of an optical apparatus according to another embodiment;

FIG. 4 is a schematic diagram of an optical apparatus according to a further embodiment; and

FIG. 5 is a flowchart of a method according to an embodiment.

### DETAILED DESCRIPTION

In the following embodiments of the present invention will be descried in detail referring to the attached figures. It is to be noted that features of different embodiments may be combined with each other unless specified otherwise. Furthermore it is to be noted that a description of an embodiment with a plurality of elements or features is not to be construed as indicating that all those features are essential for practicing the invention. Instead, other embodiments may comprise less features than shown.

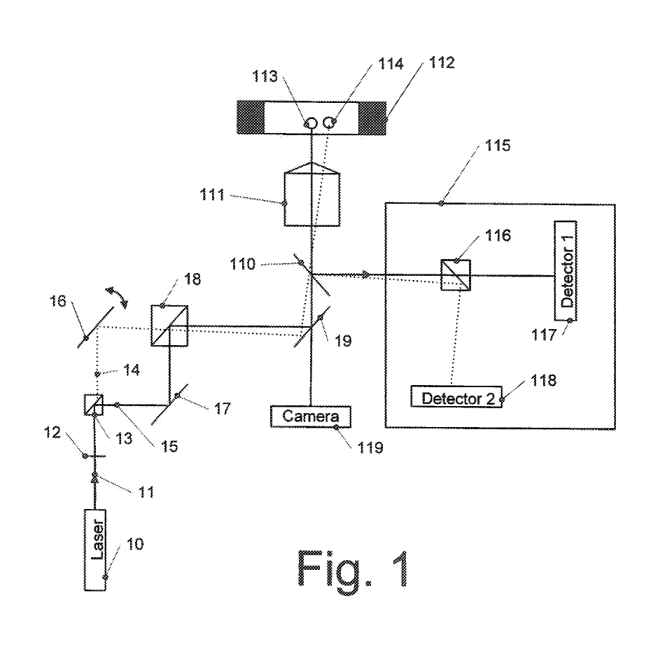

A schematic diagram of an optical arrangement according to an embodiment is shown in FIG. 1.

The embodiment of FIG. 1 comprises a laser 10 as a light source, for example an infrared laser, which generates a laser beam 11. Via a λ/2-plate 12 and a polarizing beam splitter 13, also referred to as a polar cube, laser beam 11 is split into a first beam 15 and a second beam 14 which is shown in a dotted manner. The second beam 14 is guided via a mirror 16 to a polarizing beam splitter 18, while first beam 15 is guided via a mirror 17 to polarizing beam splitter 18. Polarizing beam splitter 18 serves for combining first beam 15 and second beam 14 to a common light path. Through this arrangement first beam 15 and second beam 14 have polarizations orthogonal to each other. In an embodiment the orthogonal polarizations of first beam 15 and second beam 14 may for example be an s-polarization and a p-polarization.

As indicated by an arrow mirror 16 and/or mirror 17 may be movable to change a position of optical tweezers formed by first beam 15 and/or second beam 14, as will be further explained in the following. In other embodiments also other elements for changing the beam position/beam direction may be provided, for example an acousto-optical deflector, a spatial modulator (SLM, from the English spatial light modulator), a galvanometer scanner or another positioning element.

From beam splitter 18 first beam 15 and second beam 14 are guided for example through a beam splitter 19, for example a semitransparent mirror, and through a beam splitter 110 to a trap objective lens 111, which may be part of a microscope assembly. Trap objective lens 111 focuses first beam 15 and second beam 14 onto an object slide 12. On or in object slide 112 objects 113, 114, for example biological objects, may be present, for example in a liquid. In the example shown object 113 is trapped by optical tweezers formed by first beam 15, while object 114 is trapped in by optical tweezers formed by second beam 14. Through movable mirrors 16 and/or 17 the locations in which first object 113 and second object 114 are trapped in the respective optical tweezers are different.

Object slide 112 may be illuminated by a further light source (not shown), for example a conventional microscope illumination. Light scattered by objects on object slide 112 is guided via trap objective lens 111 through beam splitters 110 and 19 to a camera 119, thus enabling an optical control. This may assist an operator for example in controlling mirror 16 and/or 17.

Light of first beam 15 backscattered from object 113 and light of second beam 14 backscattered from object 114 is guided via trap objective lens 111 to beam splitter 110 and is there coupled out of the light path between laser 10 and trap objective lens 111 and is guided to a polarization dependent beam splitter 116, for example a polar cube, which guides backscattered light of first beam 15 to a first detector 117 and guides backscattered light from second beam 14 to a second detector 118. First detector 117 and second detector 118 detect changes of the backscattered light, for example changes of a position of an intensity maximum, wherein such changes may for example be caused through force acting on object 113 or object 114 and an associated position displacement of the respective object. Therefore by generating two orthogonally polarized light beams 14, 15 and by using polarization dependent beam splitter 116 a separate detection of a force acting on object 113 and a force acting on object 114 is possible, in particular in the backscattering geometry shown in FIG. 1.

Beam splitter 110 which serves for coupling out the backscattered laser light may have the same degree of reflection for the two orthogonal polarizations of first beam 15 and second beam 14. The position of beam splitter 110 shown in FIG. 1 is merely to be taken as an example; the coupling out may be performed in principle at each place of the path of the backscattered beam, for example as shown directly after trap objective lens 111, but also at camera 119, for example at a camera port, in an aperture plane of the beam path or at a location of a coupling of laser light into a microscope, the microscope for example comprising trap objective lens 111.

In the embodiment of FIG. 1 detectors 117, 118 may for example be positioned in a back focal plane of the arrangement. For detection of an acting force then a displacement of an intensity maximum of the beam falling on to the respective detector 117, 118 may be detected.

In other embodiments a telescope arrangement may be provided to cause a displacement of the beam falling onto the respective detector depending on a force acting on the respective object 113, 114. The telescope arrangement also may be used independently from the use of two optical tweezers with beams polarized in a different manner as described with respect to FIG. 1. Various examples for such telescope arrangements will be explained in more detail in the following.

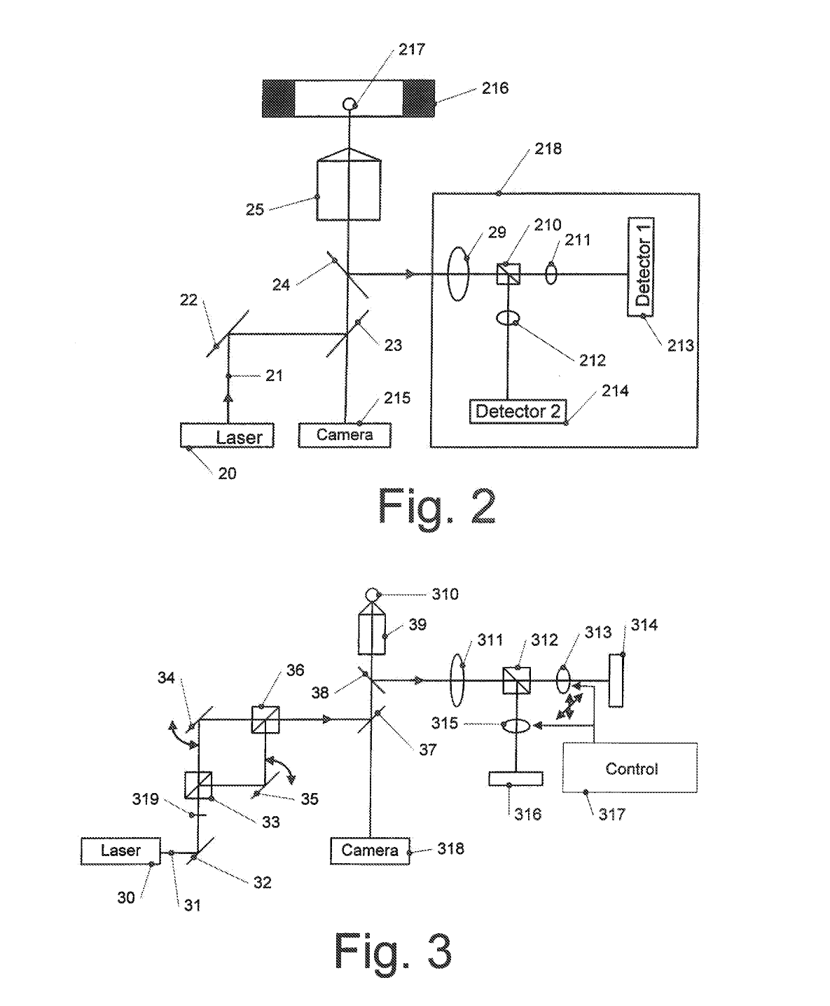

In this respect FIG. 2 shows an optical apparatus according to a further embodiment of the present invention.

In the embodiment of FIG. 2 a laser 20 generates a laser beam 21, which is guided via a mirror 22 and a beam splitter 23 and further through a beam splitter 24 to a trap objective lens 25. Trap objective lens 25 focuses the laser beam onto an object slide 216 and thus forms optical tweezers with which an object 217 may be trapped.

As in the embodiment of FIG. 1 object slide 216 may be illuminated by a light source (not shown), and therefore an optical control via a camera 215 corresponding to camera 119 of FIG. 1 may be enabled.

Laser light backscattered from object 207 is coupled out by beam splitter 24 after going through trap objective lens 25 and it is guided to a detection device 218. In detection device 218 the laser beam coupled out is guided to a first detector 213 by a reduction telescope of which a lens 29 and a lens 211 are shown.

Reduction telescope 29, 211 is preferably configured such that a diverging beam falls on first detector 213. In other words the usually essentially parallel beam falling on reduction telescope 29, 211 is converted into a diverging beam. In this case for example the distance between lenses 29, 211 may be in a range of 0.5 to 0.9, preferably 0.6 to 0.8 times the lens distance for a collimated beam after passing through the reduction telescope.

The distance of first detector 213 to lens 211 may then be chosen such that the reflection caused by the impinging beam illuminates only part of the detector area, for example between 40% and 90% of the detector area, for example about 80% of the detector area. For example, with a focal length of lens 29 of about 80 mm and a focal length of lens 211 of about −16 mm the distance to the detector may be about 75 mm, and the distance between lenses 29, 211 may be about 45 to 52 mm, whereby in this numerical example at a lens distance of 62 mm a collimated, i.e. parallel beam would fall on first detector 213.

A telescope factor of the reduction telescope formed by lenses 29 and 211 may be between 2× and 10×, for example between 4× and 5×.

The above numerical values are, however, to be understood merely as examples, and other values are possible as well.

The use of such a reduction telescope is not only possible when detecting a single beam, but is equally possible when using a plurality of beams for forming a plurality of optical tweezers. In particular, the use of a reduction telescope can also be realized when using two orthogonally polarized beams for forming two tweezers as explained with reference to FIG. 1. In such a case for example a polarization dependent beam splitter 210 corresponding to polarization dependent beam splitter 116 of FIG. 1 which performs a polarization splitting and guides a first beam with a first polarization on first detector 213 while it guides a second beam with a second polarization on a second detector 214 may for example optionally be provided in detection device 218. This polarization dependent beam splitter 210 as shown in FIG. 2 may be located between lenses 29 and 211. A further lens 212 together with lens 29 forms a further reduction telescope, the second beam being imaged with this further reduction telescope on second detector 214. In this case, the reduction telescope and the further reduction telescope thus share lens 29, while lenses 211 and 212 are provided separately. For the distance of lens 212 to lens 209 as well as for the distance between second detector 214 to lens 212 the above explanations for lenses 29, 211 and detector 213 apply correspondingly.

Two beams orthogonally polarized to each other may be generated as explained with reference to FIG. 1 using a λ2-plate and a polarizing beam splitter; however, a generation of two orthogonally polarized beams is equally possible using two separate light sources or using other types of polarizers, for example by splitting a single beam with a non-polarizing beam splitter and subsequent polarizers. In other embodiments, the beam also may differ with respect to other features than the polarization, for example with respect to wavelength, and the separation may then be performed for example using corresponding filters instead of beam splitter 210.

In embodiments where one or more beams for generating optical tweezers are movable as for example explained with reference to FIG. 1, for example displaceable, for example like first beam 15 or second beam 14 of the embodiment of FIG. 1 by moving mirror 17 or 16, respectively, a moving of the beam may lead to a corresponding reflection not falling centrally on a detector like first detector 213 or second detector 214 any longer which thus causes an undefined behaviour when a force acts on an object present in the respective optical tweezers, for example a displacement inclined with respect to the acting force, which makes a capturing of the acting force more difficult.

For compensating this in some embodiments of the invention one or more movable optical elements may be provided. A corresponding embodiment is shown in FIG. 3. The embodiment of FIG. 3 to a large extent is a combination of the embodiments of FIGS. 1 and 2.

Like the embodiment of FIG. 1, in the embodiment of FIG. 3 a first beam and a second beam are generated with a laser 30, a λ2-plate 319 and a polarizing beam splitter 33, an additional (optional) mirror 32 being provided in the beam path in the embodiment of FIG. 3. The first and the second beam may be moved, for example displaced, by mirrors 34, 35, which regarding their function correspond to mirrors 16, 17 of FIG. 1, and are guided via a polarizing beam splitter 6 and a beam splitter 37 through a beam splitter 38 to a trap objective lens 39, the function of elements 36 to 39 corresponding to the function of elements 18, 19, 110 and 111 of FIG. 1. As an example for an object trapped in thus formed optical tweezers an object 310 is shown in FIG. 3. It is equally possible to form two optical tweezers by the first beam and the second beam as explained with reference to FIG. 1, in which correspondingly two objects may be trapped. Object 310 as explained with reference to FIGS. 1 and 2 may be located in or on an object slide. For monitoring the object a camera 318 is provided as in the embodiments of FIGS. 1 and 2.

Light backscattered from one or more trapped objects is, as in the preceding embodiments, coupled out by beam splitter 38 and is guided to a detection device.

This detection device comprises a polarization dependent beam splitter 312 for separating the beams as explained with reference to FIG. 1 as well as lenses 311, 313 and 315, which form a first reduction telescope 311, 313 and a second reduction telescope 311, 315, corresponding to the ones described with reference to FIG. 2 for lenses 29, 211 and 212. A first detector 314 and a second detector 316 detect as likewise already explained with reference to FIG. 4 light beams output by the first reduction telescope and the second reduction telescope, respectively, to detect a force acting on one or more objects trapped in optical tweezers.

In the embodiment of FIG. 3, lens 313 is movable, in particular perpendicular to the optical axis, to compensate a movement of the first beam by movable mirror 35 and to ensure for example that the beam output by the first reduction telescope 311, 313 always falls essentially in the middle of detector 314, as long as no force is acting on the corresponding trapped object. Additionally or alternatively also lens 315 may be movable to compensate a moving of the second beam by movable mirror 34. The moving of lenses 313, 315 in the embodiment of FIG. 3 is controlled by a control 317.

Control 317 may for example be coupled with the control of mirrors 35 and/or 34 or may control mirror 35 and/or 34 directly and displace lens 313 and/or 315 depending on the control of mirror 35 and/or 34.

For this for example a calibration may be performed, and for each position of mirror 304 a corresponding position of lens 315 and for each position of mirror 35 a position of lens 313 may for example be stored in a table in control 317, and in operation lenses 314 and 315 may be displaced corresponding to this table depending on the controlling of mirror 35 and 34, respectively.

In another embodiment, the detector signal and/or an image of camera 318 may be used for controlling lens 313 and lens 315. In yet other embodiments, the controlling may be performed manually by a user.

In the embodiments of FIG. 1-3 light backscattered from one or more objects is used for detecting an acting force. In other embodiments, also forward scattered light may be used. An example for a detection of forward scattered light is shown in FIG. 4. The embodiment of FIG. 4 in some manner is a version of the embodiment of FIG. 3 in which instead of backscattered light forward scattered light is used for detection of an acting force. A corresponding use of forward scattered light however is also for example possible for the embodiment of FIG. 2.

In the embodiment of FIG. 4, the function of a laser 40, a mirror 41, a λ2-plate 420, a polarizing beam splitter 42, mirrors 43 and 44, a polarizing beam splitter 45, a beam splitter 46, a trap objective lens 47 and a camera 419 correspond to the already described functions of laser 30, mirror 32, λ2-plate 319, polarizing beam splitter 33, mirrors 34 and 35, polarizing beam splitter 36, beam splitter 37, trap objective lens 39 and camera 318 of FIG. 3 and therefore will not be described again in detail.

In the representation of FIG. 4 an object 48 is trapped in optical tweezers.

Light scattered by object 48 in a forward direction is collected by an objective lens 49 and is guided via a mirror 410 to a detection device 411-417. The detection device 411-417 regarding its function corresponds to the function of detection device 311-317 of FIG. 3, and corresponding elements apart from a leftmost digit bear the same reference numerals (element 311 corresponds to element 411 etc.). Therefore, the detection device is not described again. In particular, also in the embodiment of FIG. 4 lenses 413, 415 may be displaced by control 417, to compensate movements of beams used for generating optical tweezers by moving mirror 43, 44.

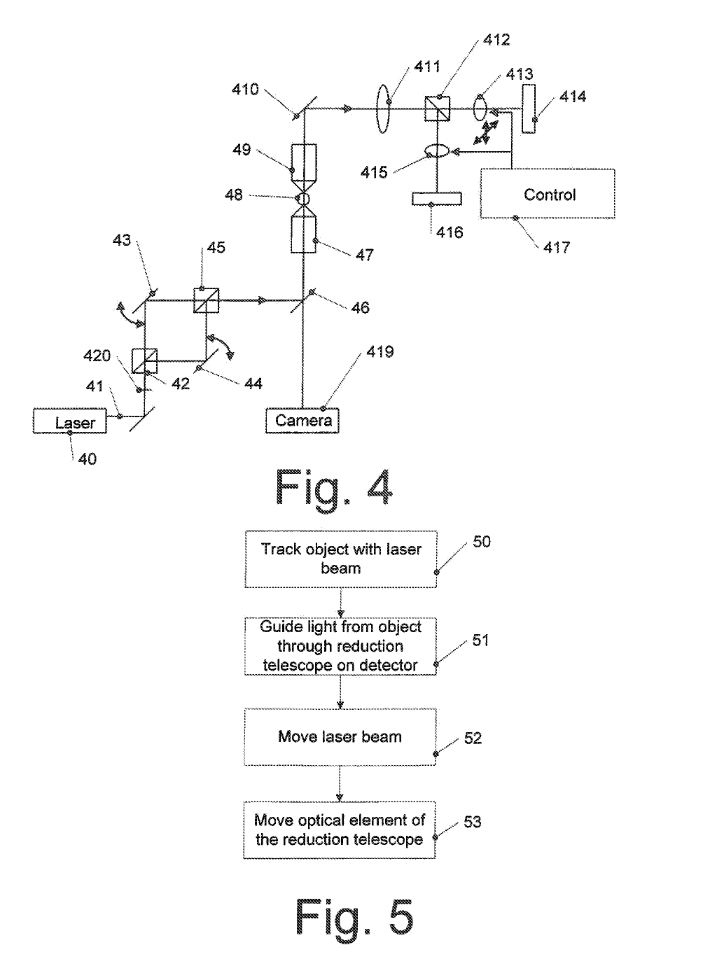

In FIG. 5, a flow chart of an embodiment of a method according to the invention is shown, wherein this method may for example as generally already described above be implemented in the embodiments of FIGS. 3 and 4, but also can be employed independent from the specific embodiments discussed above.

In step 50, an object is illuminated or trapped with a laser beam, in particular a focussed laser beam forming optical tweezers.

In step 51, scattered light, for example forward scattered light or backscattered light, is guided from the object through a reduction telescope onto a detector, to be able to thus detect forces acting on the object.

In step 52, the laser beam is moved, and in step 53 an optical element, for example a lens, of the reduction telescope is moved to compensate the moving of the laser beam from step 52 and enable a constant detection with the detector.

It is to be noted that the embodiments described above are merely examples, and a plurality of variations and modifications are possible. Some possibilities for such variations will be explained in more detail in the following. As explained for the embodiment of FIG. 2 also the embodiments of FIGS. 3 and 4 may be realized for a single beam and therefore for single optical tweezers. In this case, for example at the detection the polarization dependent beam splitter 312, lens 315 and detector 316 in case of FIG. 4 or polarization dependent beam splitter 412, lens 415 and detector 416 in case of FIG. 4 are omitted, and the splitting of the laser beam emitted by laser 30 or 40, respectively, into two beams with orthogonal polarization may be omitted.

While in the embodiments shown a camera is provided for capturing an image of an object plane, it can be omitted in other embodiments, or alternatively or additionally an optical control via a microscope without camera may be provided. The use of mirrors like mirrors 22, 32, 41 and 410 for guiding of beams depends on the relative placement of the various elements to each other desired in a specific realization, and depending on the desired placement mirrors may be omitted, additional mirrors may be provided or mirrors may be placed differently. Furthermore, additional optical elements like lenses may be provided, for example a telescope for expanding the beam emitted by laser 10, 20, 30 or 40.

The laser used may be an infrared laser in each case, however, also lasers with other wavelengths are possible.

While in the embodiments shown for each beam forming optical tweezers the detection is performed using a single detector, in other embodiments, also a further splitting of the respective beam may be provided, for example a splitting of the beam after lens 211 of FIG. 2, for example for separate detection for different spatial directions. With, a further splitting for example an independent detection in z-direction may be performed.

The reduction telescope described may for example be realized as Galilean telescope with a first plano-convex lens (lens 29, 311 or 411, respectively) and a second plano-concave lens (lenses 211, 212, 313, 315, 413, 415). Thus it can be accomplished that no focal point is present in the second lens and when using a polar cube for beam splitting, no focus point is in the polar cube.

While in the embodiments of FIG. 2-4 a first reduction telescope and a second reduction telescope have been described which have a common first lens and separate second lenses, in other embodiments, for example completely separate reduction telescopes may be located downstream the respective polarization dependent beam splitter.

In embodiments which use a single beam, the coupling out when using backscattering may be performed with aid of a polar cube instead of a beam splitter like beam splitter 24 or 38.

As detectors for example quadrant diodes or linear detectors may be employed. Such a linear detector may be configured one-dimensionally or two-dimensionally. The detectors may be adjustable, for example the position of the detectors may be displaceable.

For a quantitative measurement of the acting force, the position of the beam output from the reduction telescope on the detector may be determined and may be converted to a force for example on the basis of a previously performed calibration.

While in the embodiments of FIGS. 3 and 4 in each case a second lens of the reduction telescope has been described as movable, additionally or alternatively also the first lens may be movable. In other embodiments, instead of an arrangement with two lenses other optical arrangements, for example an optical arrangement with three lenses, may be used, and correspondingly one or more of these optical elements may be movable. For compensating a movement of the laser beam the optical elements then may be movable in particular perpendicular to the optical axis. Additionally, such optical elements may also be displaceable in the direction of the optical axis, for example to change a size of the beam on the respective detector.

As already mentioned, two orthogonally polarized beams, for example an s-polarized beam and a p-polarized beam, may not only be generated by means of a λ2-plate and following polarizing beam splitter but also in a different manner.

In the embodiments it has been described how an acting force on an object trapped in optical tweezers may be detected, in particular via a detection of a position displacement by means of a detector and a corresponding calibration, with which the detected position displacement may be assigned to a corresponding force. With the apparatuses described also a mere detection of a position displacement is possible.

For example a beam intensity may be selected thus that the forces acting at or in the focus of the laser beam are not sufficient to trap the respective illuminated object. By means of the described detection then a position displacement of the object may be detected and then a position of the beam may be adjusted accordingly, to thus be able to track movement of the object (so-called “particle tracking”).

In general, it is to be noted that a modification described for one of the above embodiments is also applicable on the other embodiments unless noted to the contrary.

1. A method for detecting a position change of an object illuminated by a light beam, comprising:
guiding of light scattered from the object to a telescope arrangement; and
detecting of a light beam output by the telescope arrangement,
wherein the telescope arrangement is configured such that the detected light beam diverges.

2. The method of claim 1, further comprising:
trapping the object in optical tweezers formed with the light beam; and
determining a force acting on the object on the basis of the detected position change.

3. The method of claim 1, wherein said detecting comprises a detection of a displacement of a light beam output by the telescope arrangement on a detector.

4. The method of claim 1, further comprising:
moving the light beam, and
moving an optical element of the telescope arrangement for compensating the movement of the light beam at the detection.

5. The method of claim 4, wherein the telescope arrangement comprises a first lens and a second lens, wherein light from the object is guided on the first lens and the beam leaves the telescope arrangement through the second lens,
wherein moving an optical element comprises moving the second lens.

6. The method of claim 1, further comprising:
providing a further light beam for illuminating a further object,
wherein the first light beam and the second light beam have different properties,
wherein said detecting comprises a separation of light scattered from the object from light scattered from the further object on the basis of the different properties,
guiding of light scattered by the further object through a further telescope arrangement, wherein the further telescope arrangement and the telescope arrangement comprise at least one common optical element and separate optical elements,
wherein the separation is performed spatially between the at least one common optical element and the separate optical elements.

7. An apparatus for detecting a position change of an object illuminated by a light beam, comprising:
a light source arrangement for generating the light beam,
an objective lens for focussing the light beam,
at least one optical element for guiding of light scattered by an object illuminated by the light beam to a telescope arrangement, and
at least one detector downstream of the telescope arrangement,
wherein the telescope arrangement is configured such that a beam falling on the at least one detector diverges.

8. The apparatus of claim 7,
wherein the objective lens and the light source arrangement are configured such that the focussed light beam forms optical tweezers.

9. The apparatus of claim 7, wherein an optical element of the telescope arrangement is movable perpendicular to the optical axis,
the apparatus further comprising:
a control for moving the optical element of the telescope arrangement, and
a further optical element for moving the at least one light beam, wherein the control is configured to move the movable optical element of the telescope arrangement depending on a movement of the further optical element for moving the at least one light beam.

10. The apparatus of claim 7, wherein the light source arrangement is configured to generate the light beam as a first light beam and a second light beam, such that the first light beam has a polarization orthogonal to the second light beam, and
wherein the apparatus further comprises:
at least one optical element for separating the scattered light on the basis of the polarization.

11. The apparatus of claim 10, wherein the optical element for separating the scattered light is located between a common first optical element of the telescope arrangement and separate optical elements of the telescope arrangement.

12. The apparatus of claim 7, wherein the telescope arrangement comprises a plano-convex lens and a plano-concave lens.
